(19) United States
(12) Patent Application Publication
(10) Pub. No.: US 2006/0278816 A1
(43) Pub. Date: Dec. 14, 2006

(54) Portable mountable indoor lamp having a positionable lamp head and motion and light sensors which can be aimed

(76) Inventor: Donald J. Booty, Cave Creek, AZ (US)

Correspondence Address: Galgano & Burke, LLP, Suite 35, 300 Rabro Drive, Hauppauge, NY, 11788, US

(21) Appl. No.: 11/449,934

(22) Filed: Jun. 9, 2006

Related U.S. Application Data
(60) Provisional application No. 60/688,929, filed on Jun. 9, 2005.

(51) Int. Cl. G06M 7/00

(52) U.S. Cl. 250/221

(57) ABSTRACT

The lamp includes a base having a battery compartment, a selector switch, an aimable light and motion sensor assembly, and a removable suction cup. A gooseneck extends from the base and terminates in a lamp head containing one or more LEDs. The LEDs are electrically coupled to a circuit in the base which is coupled to one or more batteries in the battery compartment, the selector switch, and the sensor. The selector switch allows for three modes: off, always on, and auto-on-off. In the auto-on-off mode, the lamp lights when the motion sensor detects motion unless the light sensor detects that the ambient light is above a certain level at which the lamp is not needed.

### CROSS-REFERENCE TO RELATED APPLICATIONS

This application claims benefits from U.S. Provisional Patent Application No. 60/688,929 filed Jun. 9, 2005, the contents of which are hereby incorporated herein by reference.

### BACKGROUND OF THE INVENTION

1. Field of the Invention

This invention relates broadly to indoor lighting. More particularly, this invention relates to a night light which can also be used as a task lamp.

2. State of the Art

Most people turn off all or most of the lights in their home when going to sleep. Often, however, it is necessary to awaken before dawn and find one's way in the dark until a light switch can be found. To solve this problem night lights were invented. The classic night light is a small incandescent bulb (approximately 5-7 W) mounted on an AC plug with a switch and a translucent shade. It is plugged into an outlet close to the floor and provides barely enough light to avoid tripping over obstacles. It must be manually turned on and remains on all night or longer if it is not turned off in the morning. More modern night lights have sensors which turn them on in a dark room and turn them off when the room brightens. However, they are still located near the floor and don't illuminate much else. In addition, although they turn off in the morning, they do stay on all night. More recently, night lights have been provided with motion detectors so that they only operate when needed. However they still illuminate little more than the floor. Therefore, when finding one's way to his/her destination (typically the bath room or the kitchen) one must still find a light switch which is far from the night light and is typically coupled to a light which is much too bright for eyes which have been dilated by the darkness. Stated another way, night lights are too dim and not located well and other house lights, while located well, are too bright.

### SUMMARY OF THE INVENTION

It is therefore an object of the invention to provide a lamp which is multi-positionable in a variety of directions.

It is another object of the invention to provide a lamp which is activated by motion.

It is a further object of the invention to provide a lamp which does not light in response to motion when ambient conditions are bright.

It is also an object of the invention to provide a lamp which can be used as a night light, a task lamp and a desk lamp.

It is an additional object of the invention to provide a lamp which can be located in a wide variety of locations.

It is still another object of the invention to provide a lamp with an aimable motion sensor.

In accord with these objects, which will be discussed in detail below, the lamp according to the invention includes a base having a battery compartment, a selector switch, and an aimable sensor. A gooseneck extends from the base and terminates in a lamp head containing one or more LEDs. The LEDs are electrically coupled to a circuit in the base which is coupled to one or more batteries in the battery compartment, the selector switch, and the sensor. According to the preferred embodiment, the sensor includes both a light sensor and a motion sensor and is aimable through an arc of at least 90°. The base preferably includes a removable suction cup so that the lamp can be mounted on a vertical surface or secured to a horizontal surface. The selector switch allows for three modes: off, always on, and auto-on-off. In the auto-on-off mode, the lamp lights when the motion sensor detects motion unless the light sensor detects that the ambient light is above a certain level at which the lamp is not needed. Upon detecting motion in a dark room, the lamp will light and stay lit for a predetermined time, e.g. 90 seconds, and then automatically turn off. The power supply is preferably four AA batteries, but an optional AC adapter is accommodated. In auto-on-off mode, the lamp makes an ideal night light for use in the kitchen, bathroom, bedroom, or hall. The lamp can be positioned virtually anywhere with the sensor pointed toward the expected approach and the lamp head pointed toward what is to be illuminated. The LEDs are very bright and efficient. They will operate more than 250 hours when powered by four M batteries. In the always on mode, the lamp provides bright light for a desk for the office or at home for crafts or hobbies. In auto-on-off mode, it also serves well as a closet light or a garage or basement light.

Additional objects and advantages of the invention will become apparent to those skilled in the art upon reference to the detailed description taken in conjunction with the provided figures.

### BRIEF DESCRIPTION OF THE DRAWINGS

FIG. 1 is a perspective view looking down at the lamp;

FIG. 2 is a broken perspective view of the lamp mounted on a vertical surface;

FIG. 3 is a broken perspective view illustrating the aimable sensors;

FIG. 4 is a broken perspective view illustrating the battery compartment;

FIG. 5 is a broken perspective view illustrating the removable suction cup;

FIG. 6 is a broken side elevation view illustrating the sensor assembly in a first position;

FIG. 7 is a broken side elevation view illustrating the sensor assembly in a second position;

FIG. 8 is a broken side elevation view illustrating the sensor assembly in a third position;

FIG. 9 is a left side elevation view;

FIG. 10 is a right side elevation view;

FIG. 11 is a front side elevation view;

FIG. 12 is a rear side elevation view;

FIG. 13 is a top plan view;

FIG. 14 is a bottom plan view; and

FIG. 15 is a high level schematic diagram of the electronic components of the lamp;

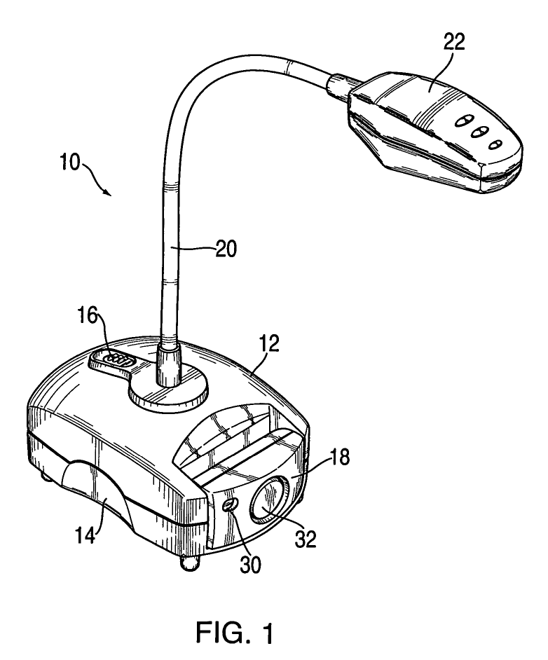

### DETAILED DESCRIPTION

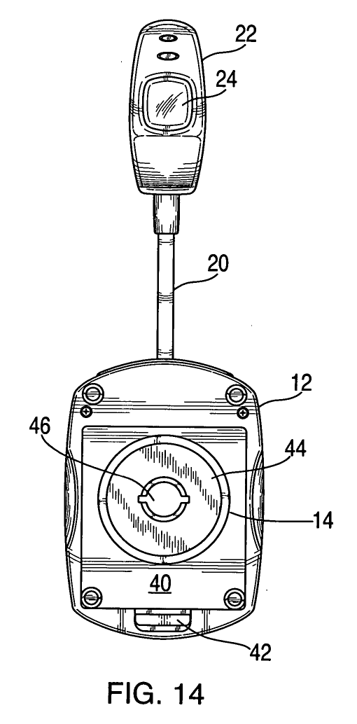

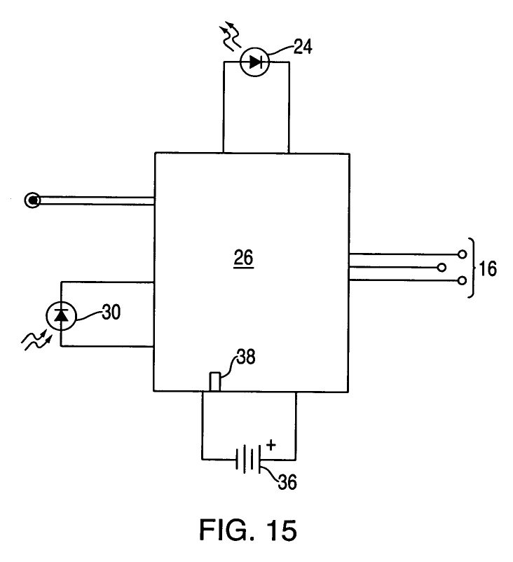

Turning now to the Figures generally, the lamp 10 according to the invention includes a base 12 having a battery compartment 14 (seen best in FIG. 4), a selector switch 16, and an aimable sensor assembly 18. A gooseneck 20 extends from the base 12 and terminates in a lamp head 22 containing one or more LEDs 24 (seen best in FIG. 14). The LEDs 24 are electrically coupled to a circuit 26 (FIG. 15) in the base 12 which is coupled to one or more batteries 28 in the battery compartment 14, the selector switch 16, and the sensor assembly 18.

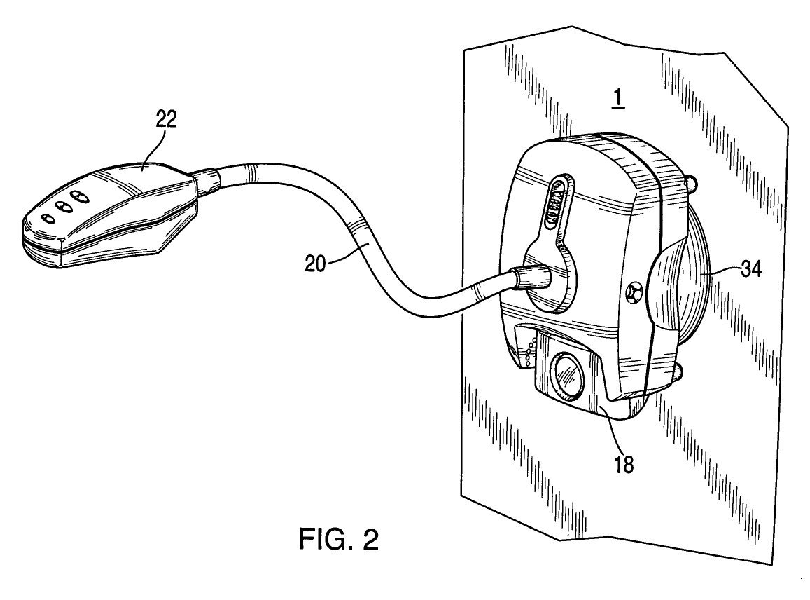

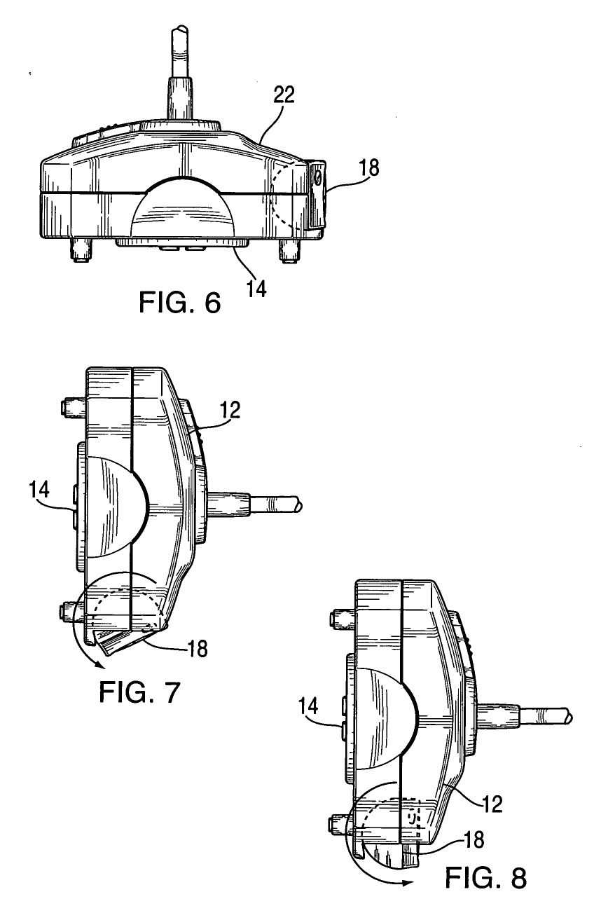

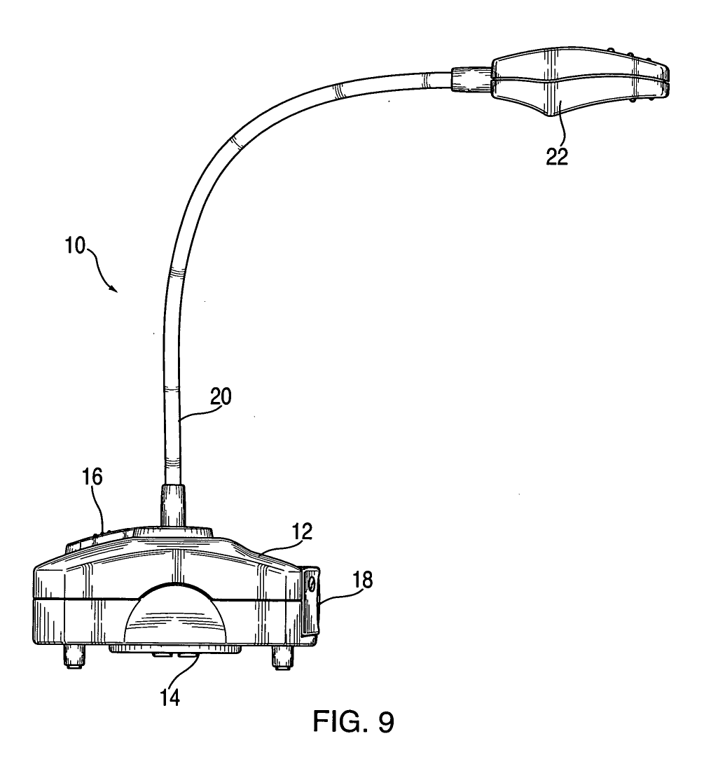

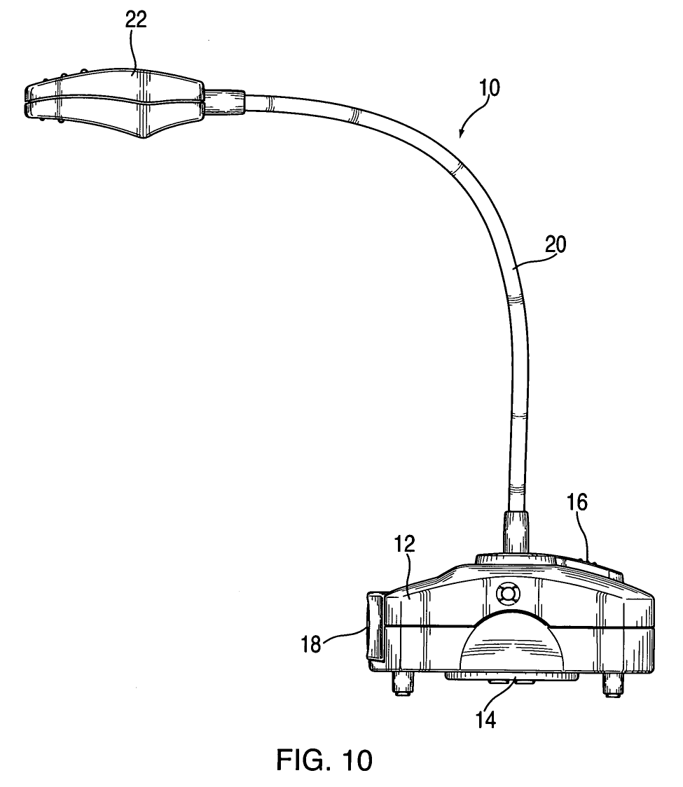

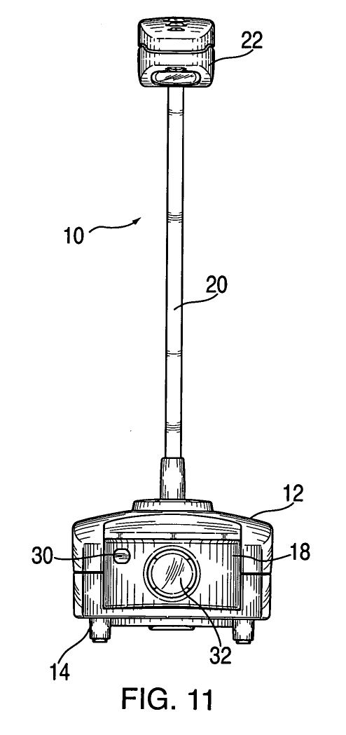

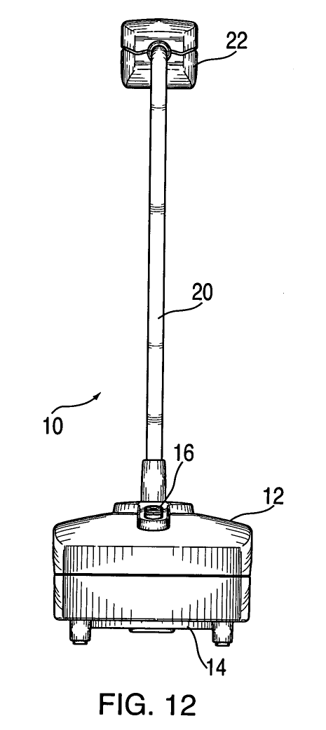

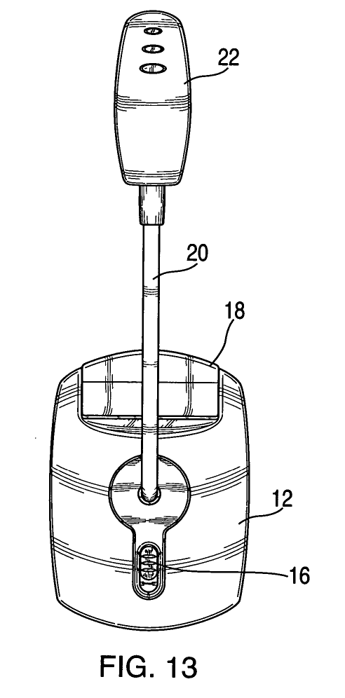

According to the preferred embodiment, the sensor assembly 18 includes both a light sensor 30 and a motion sensor 32 and is aimable through an arc of at least 90° as shown in FIGS. 6-8. The base 12 preferably includes a removable suction cup 34 (seen best in FIG. 5) so that the lamp 10 can be mounted on a vertical surface 1 as shown in FIG. 2 or secured to a horizontal surface (not shown).

The selector switch 16 allows for three modes: off, always on, and auto-on-off. In the auto-on-off mode, the lamp lights when the motion sensor 32 detects motion unless the light sensor 30 detects that the ambient light is above a certain level at which the lamp is not needed. Upon detecting motion in a dark room, the circuit 26 will light the lamp and keep it lit for a predetermined time, e.g. 90 seconds, and then turn it automatically turn off unless additional motion is detected. The power supply is preferably four M batteries 36 (FIG. 4), but an optional AC adapter (not shown) is accommodated by a jack 38. In auto-on-off mode, the lamp makes an ideal night light for use in the kitchen, bathroom, bedroom, or hall. The lamp can be positioned virtually anywhere with the sensor pointed toward the expected approach and the lamp head pointed toward what is to be illuminated. The LEDs are very bright and efficient. They will operate more than 250 hours when powered by four AA batteries. In the always on mode, the lamp provides bright light for a desk for the office or at home for crafts or hobbies. In auto-on-off mode, it also serves well as a closet light or a garage or basement light.

Turning now to FIGS. 4, 5, and 14, it will be seen that the battery compartment 14 has an access door 40 which is opened and secured with a live hinge catch 42. The access door is provided with a raised central circular portion 44 which defines a keyed hole 46. The removable suction cup 34 is provided with a keyed stem 48 (seen best in FIG. 5) which is received by the hole 46. It will be appreciated that the reason why the circular portion 44 is raised is to provide a space above the batteries to receive the stem 48.

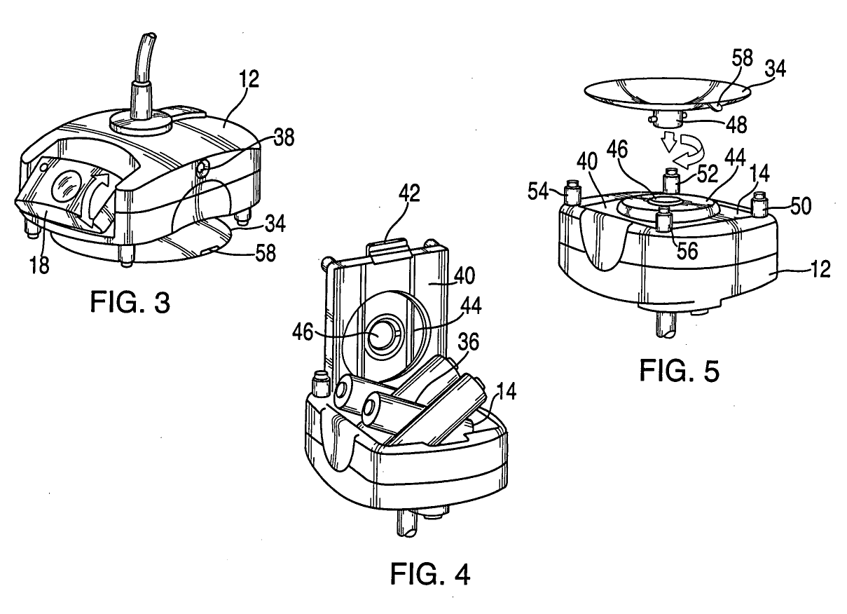

As seen best in FIG. 5, the base 12 is provided with four feet 50, 52, 54, 56 which, when the suction cup is removed provide a space between the base and a surface for the raised portion 44 of the access door 40. As seen best in FIGS. 3 and 5, the suction cup 34 is provided with a radially extending tab 58 which can be pulled to facilitate removing the suction cup from a surface.

There has been described and illustrated herein a portable mountable indoor lamp having a positionable lamp head and motion and light sensors which can be aimed. While a preferred embodiment of the invention has been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. An indoor portable lamp, comprising:
a base;
a gooseneck extending upward from the base and having a terminal end;
a lamp head coupled to the terminal end of the gooseneck;
at least one LED mounted in the lamp head;
a circuit in the base and electrically coupled to the at least one LED;
a switch electrically coupled to the circuit;
a photo sensor electrically coupled to the circuit; and
a motion sensor electrically coupled to the circuit, wherein
the switch is operable between at least two positions such that in the first position the lamp lights if coupled to a source of power and in the second position the lamp lights if coupled to a source of power and the motion sensor detects motion but the photo sensor does not detect light.

2. The lamp according to claim 1, wherein:
the circuit includes a timer such that when the switch is in the second position, the timer counts down and if no motion is detected by the motion sensor while the timer counts down, the lamp shuts off when the timer expires.

3. The lamp according to claim 1, further comprising:
a suction cup removably attached to the base.

4. The lamp according to claim 1, wherein:
the photo sensor and the motion sensor are aimable.

5. The lamp according to claim 1, wherein:
the photo sensor and the motion sensor are mounted in an assembly which is movable relative to the base.

6. The lamp according to claim 5, wherein:
the assembly is pivotable.

7. The lamp according to claim 6, wherein:
the assembly is pivotable through an arc of 90°.

8. The lamp according to claim 1, further comprising:
a jack for an AC adapter mounted in the base and electrically coupled to the circuit.

9. The lamp according to claim 6, wherein:
the gooseneck has a starting axis which is substantially vertical when the base is placed on a horizontal surface and the pivot axis of the assembly is substantially horizontal.

10. The lamp according to claim 3, wherein:
the base defines a keyed hole and the suction cup has a keyed pin which engages the keyed hole.
